(19) United States
(12) Patent Application Publication
(10) Pub. No.: US 2016/0224149 A1
(43) Pub. Date: Aug. 4, 2016

(54) TOUCH SENSOR

(71) Applicant: SAMSUNG DISPLAY CO., LTD., Yongin-si (KR)

(72) Inventors: Ki Nyeng KANG, Seoul (KR); Jong Hyun CHOI, Seoul (KR); Sang Jo LEE, Hwaseong-si (KR); Ji Won HAN, Anyang-si (KR); Jung-Moo HONG, Seoul (KR); Seung Peom NOH, Seoul (KR); Seung Rok LEE, Yongin-si (KR)

(21) Appl. No.: 14/857,983

(22) Filed: Sep. 18, 2015

(30) Foreign Application Priority Data
Feb. 3, 2015 (KR) 10-2015-0016956

(51) Int. Cl. G06F 3/044

(52) U.S. Cl. CPC G06F 3/044

(57) ABSTRACT

A touch sensor includes a plurality of touch electrodes on a touch area to sense touch, each of the touch electrodes having a plurality of branch electrodes parallel to each other in a first direction, and connection lines on the touch area and connected to the touch electrodes, the connection lines extending in the first direction in parallel to the branch electrodes, wherein a width of the connection line and a width of the branch electrode are equal to each other.

### CROSS-REFERENCE TO RELATED APPLICATION

Korean Patent Application No. 10-2015-0016956, filed on Feb. 3, 2015, in the Korean Intellectual Property Office, and entitled: “Touch Sensor,” is incorporated by reference herein in its entirety.

### BACKGROUND

1. Field

The present disclosure relates to a touch sensor, and more particularly, to a touch sensor included in a touch panel.

2. Description of the Related Art

Display devices, e.g., a liquid crystal display (LCD), an organic light emitting diode (OLED) display, and the like, portable transmitters, other information processing devices, and the like perform functions thereof using various input devices. Recently, as the above-mentioned input devices, an input device including a touch sensing device has been mainly used.

The touch sensing function refers to a function detecting touch information, e.g., whether or not an object approaches or touches a screen and a touch location of the object by sensing, by the display device, a change in pressure, charge, and light which are applied to a screen thereof in the case in which a user approaches or touches the screen with a finger or a touch pen, e.g., so as to write letters or make a picture on the screen. The display device may receive an image signal and display an image based on the touch information.

The touch sensing function may be implemented by a touch sensor. The touch sensor may be classified depending on various touch sensing types, e.g., a resistive type, a capacitive type, an electromagnetic resonance (EMR) type, and an optical type.

For example, in a case of the resistive type touch sensor, two electrodes spaced apart from each other so as to face each other may be in contact with each other by pressure by an external object. When two electrodes are in contact with each other, the resistive type touch sensor may detect a contact position by recognizing a voltage change depending on a resistance change at the contact position. In another example, the capacitive type touch sensor includes a sensing capacitor configured of touch electrodes capable of transmitting a sensing signal, and may sense a change in capacitance of the sensing capacitor generated when a conductor, e.g., the finger, approaches the sensor, so as to detect whether or not the conductor touches the sensor, the touch location thereof, and the like.

Such touch sensing sensor may be formed in the touch panel so as to be attached on the display device (add-on cell type), may also be formed out of a substrate of the display device (on-cell type), and may also be formed in the display device (in-cell type). The display device including the touch sensing sensor may detect whether or not the finger of the user or the touch pen touches the screen and the touch location information thereof, and may display an image accordingly.

### SUMMARY

An exemplary embodiment provides a touch sensor including a plurality of touch electrodes on a touch area to sense touch, each of the touch electrodes having a plurality of branch electrodes parallel to each other in a first direction, and connection lines on the touch area and connected to the touch electrodes, the connection lines extending in the first direction in parallel to the branch electrodes, wherein a width of the connection line and a width of the branch electrode are equal to each other.

The connection lines and the branch electrodes may be disposed at an equidistant interval in the touch area.

A width between the connection lines may be equal to the width of the connection line.

A width between the branch electrodes may be equal to the width of the branch electrode.

A width between the branch electrodes may be different from the width of the branch electrode.

The touch sensor may further include at least one connection electrode connecting neighboring branch electrodes.

The connection electrode may be connected to the branch electrode to be perpendicular to the branch electrode.

The connection electrode may be disposed at one side of an opening part formed between the neighboring branch electrodes.

The connection electrode may connect the neighboring branch electrodes across the opening part.

The touch electrodes may be disposed in rows and columns.

A plurality of connection lines which are each connected to the touch electrode disposed in any one column among the rows and columns may be disposed between columns of neighboring touch electrodes.

Facing sides of the touch electrodes which are adjacent in the column direction may have a step shape.

The step shapes of the facing sides may be formed so as to be engaged with each other.

The facing sides may have the step shape formed in a direction in which the facing sides are repeatedly increased or decreased as the facing sides become distant from the connection line.

The width of the connection line and the width of the branch electrode may be 10 μm to 100 μm.

The touch electrode may include at least one of indium tin oxide (ITO), indium zinc oxide (IZO), a metal nanowire, and conductive polymer.

### BRIEF DESCRIPTION OF THE DRAWINGS

Features will become apparent to those of ordinary skill in the art by describing in detail exemplary embodiments with reference to the attached drawings, in which:

FIG. 1 illustrates a schematic layout view of a touch screen panel including a touch sensor according to an exemplary embodiment of the present disclosure.

FIG. 2 illustrates a plan view of a touch sensor according to an exemplary embodiment of the present disclosure.

FIG. 3 illustrates an enlarged view of a portion of FIG. 2.

FIGS. 4-7 illustrate plan views of touch sensor according to other exemplary embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers or elements may also be present. In addition, when it is described that an element is “coupled” to another element, the element may be “directly coupled” to the other element or “electrically coupled” to the other element through a third element. Further, it will also be understood that when a layer is referred to as being “between” two layers, it can be the only layer between the two layers, or one or more intervening layers may also be present. Like reference numerals refer to like elements throughout.

In addition, unless explicitly described to the contrary, the word “comprise” and variations such as “comprises” or “comprising”, will be understood to imply the inclusion of stated elements but not the exclusion of any other elements.

Hereinafter, a touch sensor according to an exemplary embodiment of the present disclosure will be described in detail with reference to the accompanying drawings.

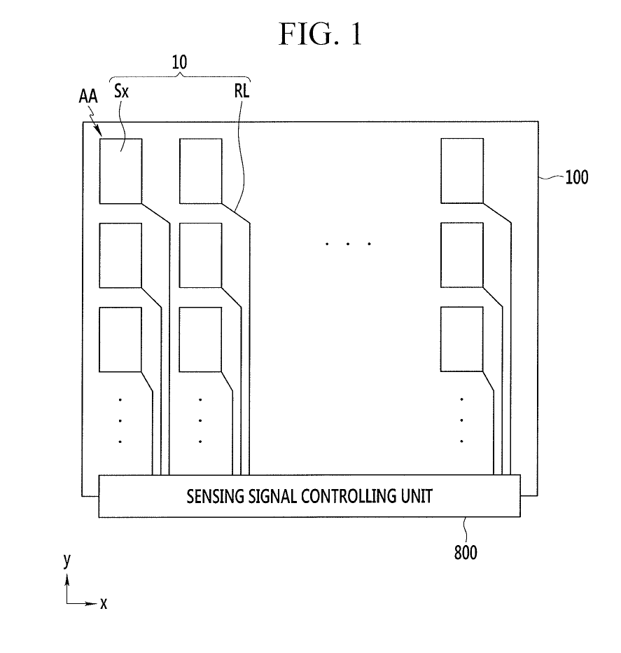

FIG. 1 illustrates a schematic layout view of a touch panel including a touch sensor according to an exemplary embodiment of the present disclosure.

As shown in FIG. 1, a touch panel according to an exemplary embodiment of the present disclosure may include a touch sensor 10 formed on a substrate 100 and a sensing signal controlling unit 800 connected to the touch sensor 10. The touch sensor 10 according to an exemplary embodiment of the present disclosure, which is a touch sensor capable of sensing a touch of an external object, may be any suitable type of touch sensor, but a capacitive type touch sensor will be described in the present exemplary embodiment by way of example.

The touch sensor 10 may be included in a display panel or in a separate touch panel, so as to sense the touch. An example in which the touch sensor is included in the touch panel will be mainly described in the present exemplary embodiment. Here, the touch includes a case in which an external object approaches the display panel or the touch panel, as well as a case in which the external object is directly in contact with the display panel or the touch panel.

The touch sensor 10 according to an exemplary embodiment of the present disclosure may include a plurality of touch electrodes Sx disposed on an active area AA and a plurality of connection lines RL connected to the touch electrodes Sx. The active area AA, i.e., an area to which the touch may be applied and from which the touch may be sensed, may be overlapped with a display area, on which an image is displayed, in a case of the display panel, for example. In a case of the touch panel, the active area may be a touch area, and in the case in which the touch panel is embedded in the display panel, the touch area may be overlapped with the display area. Hereinafter, the active area AA is also referred to as the touch area.

As illustrated in FIG. 1, the plurality of touch electrodes Sx may be arranged in rows and columns form, and may be formed on a same layer as each other in a cross-sectional structure. For example, as illustrated in FIG. 1, the plurality of touch electrodes Sx may be arranged in a same layer in a matrix pattern along the x-axis and the y-axis. Each touch electrode Sx may include a transparent conductive material, e.g., indium tin oxide (ITO) and indium zinc oxide (IZO), and a metal nanowire, e.g., a silver (Ag) nanowire, but is not limited thereto.

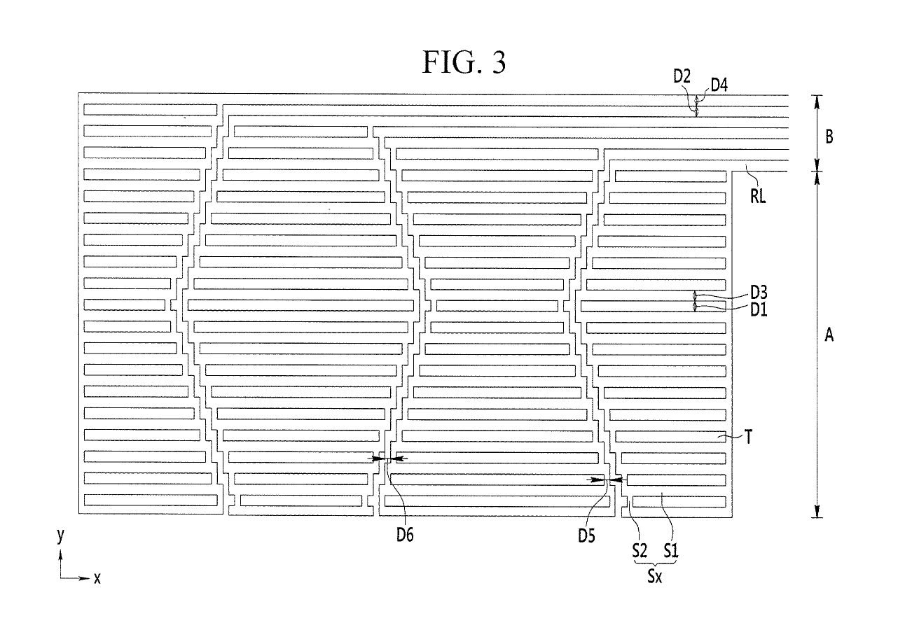

The touch electrode Sx may have a quadrangular shape as shown in FIG. 1, but is not limited thereto. For example, the touch electrode Sx may have various shapes. Referring to FIG. 3 to be described below, the touch electrode Sx may have an edge side formed in a step shape in order to increase touch sensitivity. In the case in which the edge side of the touch electrode Sx includes the step shape, the edge side may be engaged, e.g., complementary, with a side having the step shape of a neighboring touch electrode Sx.

Referring back to FIG. 1, a length of one side of the touch electrode Sx may be approximately several mm. For example, a length of one side of the touch electrode Sx may be about 10 mm or less, e.g., about 4 mm to about 5 mm, but a size of the touch electrode Sx may be adjusted depending on touch sensing resolution.

The plurality of touch electrodes Sx may be separated from each other in the touch area, e.g., along the x-axis and the y-axis. Different touch electrodes Sx may be connected to the sensing signal controlling unit 800 through different connection lines RL, e.g., each touch electrodes Sx may be connected to the sensing signal controlling unit 800 through a separate connection lines RL to operate independently of each other.

The touch electrodes Sx according to an exemplary embodiment of the present disclosure may receive a sensing input signal from the sensing signal controlling unit 800 through the respective connection lines RL, and generate a sensing output signal according to the touch so as to be transmitted to the sensing signal controlling unit 800.

Each touch electrode Sx may form a self sensing capacitor so as to be charged with a predetermined charge amount after receiving the sensing input signal. Thereafter, when the external object, e.g., a finger, touches the touch panel, the charge amount charged in the self sensing capacitor may be changed, such that a sensing output signal different from the received sensing input signal may be output. Touch information, e.g., whether or not the object touches the touch panel and a touch position, may be detected through the sensing output signal generated as described above.

The connection lines RL connect the touch electrodes Sx and the sensing signal controlling unit 800, so as to transmit the sensing input signal or the sensing output signal. The connection lines RL may be disposed on the same layer as the touch electrodes Sx and may be made of the same material as the touch electrodes Sx. However, the present disclosure is not limited thereto, e.g., the connection lines RL may be disposed on a layer different from the touch electrode Sx and may also be connected to the touch electrode Sx through a separate connection part.

Meanwhile, the closer the sensing signal controlling unit 800, the more the number of connection lines RL disposed between the touch electrodes Sx included in a row disposed so as to be adjacent to the sensing signal controlling unit 800. Therefore, the closer the sensing signal controlling unit 800, the smaller a size of the touch electrode Sx or a width of the touch electrode Sx (i.e., a width of a side traversing between neighboring connection lines along the x-axis).

A width of a connection line RL may be approximately about 10 μm to about 100 μm, but is not limited thereto.

The sensing signal controlling unit 800 is connected to the touch electrodes Sx of the touch panel so as to transmit the sensing input signal to the touch electrodes Sx and to receive the sensing output signal from the touch electrodes Sx. The sensing signal controlling unit 800 may generate the touch information, e.g., whether or not the object touches the touch panel and the touch position, by processing the sensing output signal.

For example, the sensing signal controlling unit 800 may also be disposed on a printed circuit board independent of the substrate 100 of the touch panel so as to be connected to the touch panel. In another example, the sensing signal controlling unit 800 may also be attached onto the substrate 100 of the touch panel in a form of an integrated chip or a TCP form, and may also be integrated on the substrate 100.

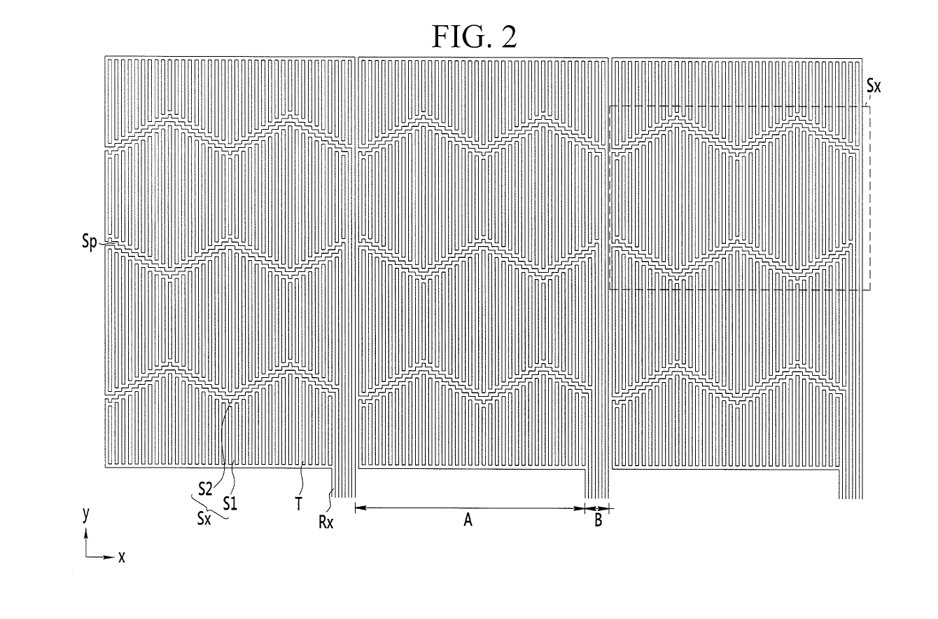

Hereinafter, a touch sensor according to an exemplary embodiment of the present disclosure will be described in detail with reference to FIGS. 2-3.

FIG. 2 illustrates a plan view of a touch sensor according to an exemplary embodiment of the present disclosure. FIG. 3 is an enlarged view of a touch electrode disposed in any one column of FIG. 2.

For example, FIG. 2 illustrates a case in which the touch electrodes Sx are disposed in four rows along the x-axis and in three columns along the y-axis, and are separated from each other by a space SP. As an example, one touch electrode Sx is indicated by a dashed frame. However, the present disclosure is not limited thereto, e.g., the touch electrodes may have any suitable number of rows and columns. FIG. 3 illustrates an enlarged view showing a first column of the touch electrodes Sx in FIG. 2 along the y-axis. In this case, a direction to which the connection line RL is extended is a column direction, i.e., along the y-axis, and a direction intersecting with the connection line RL is a row direction, i.e., along the x-axis.

As shown in FIGS. 2 and 3, the touch electrode Sx has a plurality of opening parts T spaced apart from each other. Each of the opening parts T may be formed in a long quadrangle in the same direction as the connection line RL, i.e., along the y-axis, and may be spaced apart from an adjacent opening part T along the x-axis. Therefore, the touch electrode Sx includes a plurality of branch electrodes S1 disposed between the opening parts T, and a connection electrode S2 connected to first ends of the branch electrodes S1. That is, as illustrated in FIG. 2, each branch electrode S1 extends between two adjacent opening parts T, and the first end of each branch electrode S1 is connected to the connection electrode S2. Since the connection electrode S2 is disposed, e.g., only, at one side of the opening part T having the quadrangular shape so as to connect the branch electrodes S1, the connection electrode S2 may be connected to the first ends of the branch electrodes S1 to be perpendicular thereto, i.e., the connection electrode S2 may extend along the x-axis.

When an area in which the touch electrodes Sx are disposed is defined as a sensing area A and an area in which the connection lines RL are disposed is defined as a line area B, pattern densities of the sensing area A and the line area B may be the same. In this case, the pattern is the branch electrodes S1 and the connection lines RL, and the pattern density may be determined by a width and an arrangement interval of the branch electrodes S1 and the connection lines RL.

Therefore, in order to allow the pattern density to be equal, a width D1 of the opening part T is equal to a width D2 between two neighboring connection lines RL (FIG. 3). Further, a width D3 of the branch electrode S1 is equal to a width D4 of the connection line RL (FIG. 3). In this case, a width D5 of the connection electrode S2 may also be equal to the width D3 of the branch electrode S1. The width of each of the connection line RL and the width of the branch electrode S1 may be about 10 μm to about 100 μm. Although FIGS. 2 and 3 illustrate the width D1 of the opening part T, the width D2 between the neighboring connection lines RL, the width D3 of the branch electrode S1, and the width D4 of the connection line RL as equal, the present disclosure is not limited thereto.

Meanwhile, as illustrated in FIG. 3, facing sides of two touch electrodes Sx which are adjacent in a column direction, i.e., along the y-axis, are each formed in a step shape. That is, the facing sides of the two touch electrodes Sx are formed in the step shape by having branch electrodes S1 adjacent to each other in the row direction, i.e., along the x-axis, increased or decreased by a predetermined length in a column direction, i.e., along the y-axis.

The reason is that the length of the branch electrode S1 or the opening part T of the touch electrode Sx is changed while being repeatedly increased or decreased as the branch electrode S1 or the opening part T is closer to the connection line RL, and the connection electrode S2 connects the branch electrodes S1. In addition, although FIG. 3 shows a case in which the sides of neighboring touch electrodes Sx repeat twice a gradual increase or decrease in the row direction, the present disclosure is not limited thereto, e.g., the sides of the neighboring touch electrodes Sx may be formed by repeating once or three or more times the gradual increase or decrease in the row direction.

In FIG. 3, since the length of the branch electrode S1 is gradually changed as much as the width of the branch electrode S1 or the width of the connection electrode S2, a height D6 of the step may be the same as the width D3 of the branch electrode S1 or the width D5 of the connection electrode S2.

As described above, according to an exemplary embodiment of the present disclosure, since the densities of the patterns disposed in the sensing area A and the line area B are equal to each other by forming the width D1 of the opening part T so as to be equal to the width D2 between the connection lines RL, and forming the width D3 of the branch electrode S1 so as to be equal to the width D4 of the connection line RL, a pattern visibility phenomenon due to haze, or the like may be decreased in the touch panel. In addition, according to an exemplary embodiment of the present disclosure, since the length of the connection electrode S2 is minimized and an area of the connection electrode S2 is reduced by connecting the connection electrode S2 to the branch electrode S1 so as to be perpendicular thereto, the pattern visibility phenomenon due to the haze may be decreased in the touch panel.

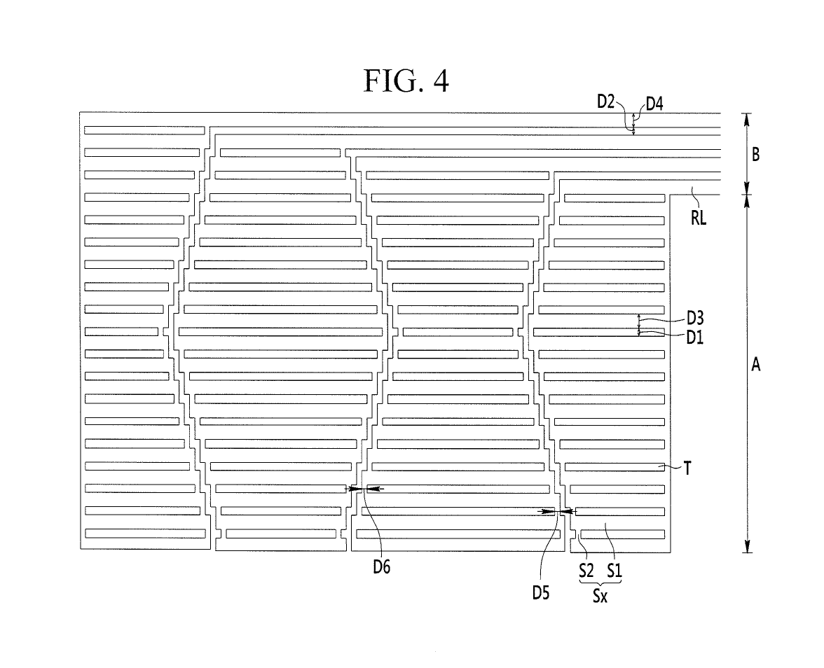

FIGS. 4-7 illustrate plan views of a touch sensor according to other exemplary embodiments.

Referring to FIG. 4, the touch sensor is substantially the same as the touch sensor of FIG. 3, so only different parts will be described in more detail.

As shown in FIG. 4, the touch sensor includes the touch electrodes Sx and the connection lines RL connected to the touch electrodes Sx. Each touch electrode Sx has a plurality of opening parts T, and the touch electrode Sx includes the plurality of branch electrodes S1 disposed between the opening parts T and the connection electrode S2 connected to the first ends of the branch electrodes S1. Since the connection electrode S2 is disposed only at one side of the opening parts T having the quadrangular shape so as to connect the branch electrodes S1, it may be connected to the branch electrode S1 to be perpendicular thereto.

The width D1 of the opening part T of the touch electrode Sx shown in FIG. 4 is equal to the width D2 between the connection lines RL, and the width D3 of the branch electrode S1 is equal to the width D4 of the connection line RL. In this case, the width D1 of the opening part and the width D2 between the connection lines RL may be different from the width D3 of the branch electrode and the width D4 of the connection line RL.

That is, as shown in FIG. 4, the width D1 of the opening part and the width D2 between the connection lines RL may be narrower than the width D3 of the branch electrode and the width D4 of the connection line RL. In addition, the width D1 of the opening part and the width D2 between the connection lines RL may be wider than the width D3 of the branch electrode and the width D4 of the connection line RL (not shown). By forming the widths of the branch electrode S1 and the connection line S2 to be equal to each other and disposed at the same interval, densities of patterns in the sensing area A and the line area B may be equal to each other.

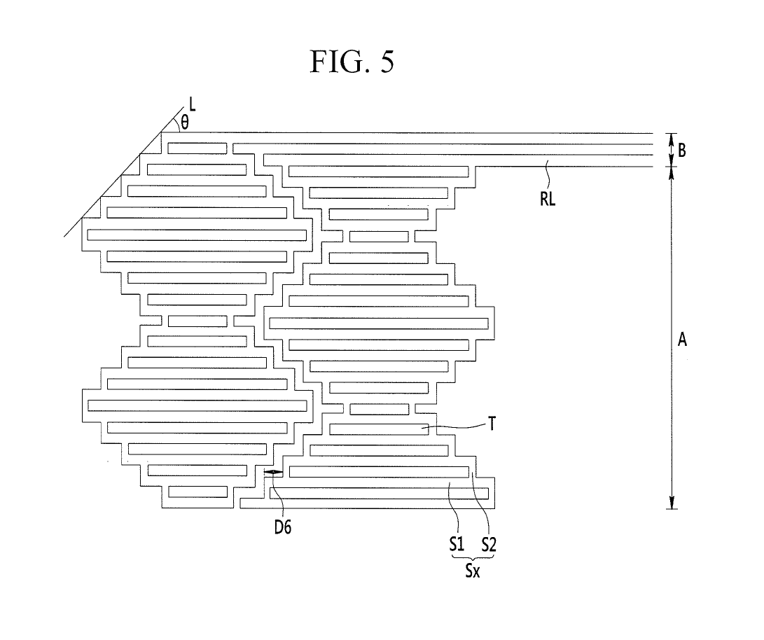

Referring to FIG. 5, the touch sensor is substantially the same as the touch sensor of FIG. 3, so only different parts will be described in more detail.

As shown in FIG. 5, the touch sensor includes the touch electrodes Sx and the connection lines RL connected to the touch electrodes Sx. Each touch electrode Sx has a plurality of opening parts T, and the touch electrode Sx includes the plurality of branch electrodes S1 disposed between the opening parts T and the connection electrode S2 connected to one ends of the branch electrodes S1. Since the connection electrode S2 is disposed at only one side of the opening part T having the quadrangular shape so as to connect the branch electrodes S1, it may be connected to the branch electrode S1 to be perpendicular thereto.

In this case, since the width D1 of the opening part T, the width D2 between the neighboring connection lines RL, the width D3 of the branch electrode S1, the width D4 of the connection line RL, and the width D5 of the connection electrode S2 are all equal, densities of patterns in the sensing area A and the line area B are equal to each other.

Meanwhile, the length of the opening part T or the length of the branch electrode S1 is gradually changed, as much as the width D5 of the connection electrode S2 in FIG. 3, but the length of the opening part T or the length of the branch electrode S1 of FIG. 5 may be changed as much as a width different from the width of the connection electrode S2. Therefore, a height D6 of a step of the facing sides of the neighboring touch electrodes of FIG. 5 is larger than the width D5 of the connection electrode S2. Further, the height D6 of the step may be smaller than the width of the connection electrode S2 (not shown).

If the height of the step is changed, an angle θ formed by a virtual diagonal line L connecting vertices of the sides of the touch electrode Sx and the connection line RL is changed. As shown in FIG. 5, if the height of the step is increased, the angle formed by the virtual diagonal line L and the connection line RL may be smaller than an angle formed by a virtual diagonal line of the touch electrode and the connection line RL as shown in FIG. 3.

This is to diverse, e.g., vary, the lengths of the sides of the touch electrode Sx depending on sensing capacity of the touch electrode Sx. The lengths of the touch electrode Sx may be easily changed by changing the length of the opening part T and the length of the branch electrode S1.

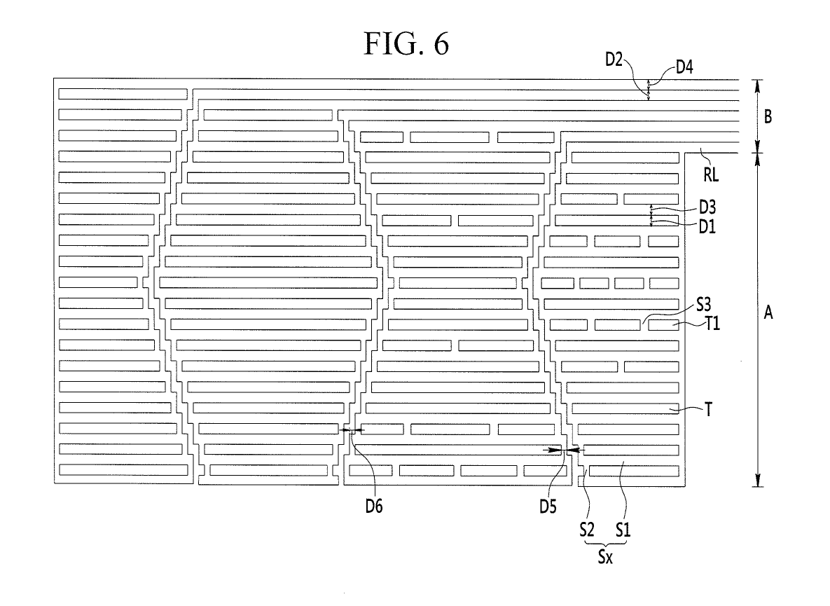

Referring to FIG. 6, the touch sensor is substantially the same as the touch sensor of FIG. 3, so only different parts will be described in more detail.

As shown in FIG. 6, the touch sensor includes the touch electrodes Sx and the connection lines RL connected to the touch electrodes Sx. Each touch electrode Sx has a plurality of opening parts T, and the touch electrode Sx includes the plurality of branch electrodes S1 disposed between the opening parts T and the connection electrode S2 connected to first ends of the branch electrodes S1. Since the connection electrode S2 is disposed at one side of the opening part T having the quadrangular shape so as to connect the branch electrodes S1, it may be connected to the branch electrode S1 to be perpendicular thereto.

In addition, the touch sensor further includes an auxiliary connection electrode S3 connecting two neighboring branch electrodes S1 and the branch electrode S1. The auxiliary connection electrode S3 is disposed in the opening part T, and the opening part T may be divided into a plurality of small opening parts T1 by the auxiliary connection electrode S3.

Since the auxiliary connection electrode S3 connects the branch electrodes S1, a current flows through the auxiliary connection electrode S3 even when some of the branch electrodes S1 are disconnected. Therefore, when some of the branch electrodes S1 are disconnected, RC delay may be reduced by minimizing a movement path of the current in the touch electrode. Further, since haze may occur as the number of auxiliary connection electrodes S3 is increased, the number of auxiliary connection electrodes S3 formed in the opening part T may be 0 to 4.

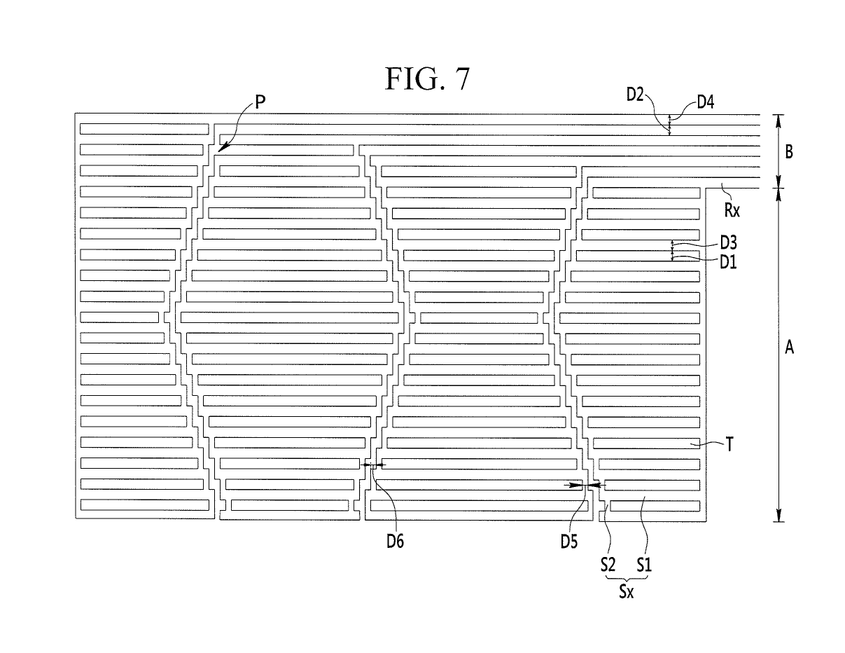

Referring to FIG. 7, the touch sensor is substantially the same as the touch sensor of FIG. 3, so only different parts will be described in more detail.

As shown in FIG. 7, the touch sensor includes the touch electrodes Sx and the connection lines RL connected to the touch electrodes Sx. The touch electrode Sx has a plurality of opening parts T, and the touch electrode Sx includes the plurality of branch electrodes S1 disposed between the opening parts T and the connection electrode S2 connected to first ends of the branch electrodes S1. Since the connection electrode S2 is disposed at one side of the opening part T having the quadrangular shape so as to connect the branch electrodes S1, it may be connected to the branch electrode S1 to be perpendicular thereto.

A touch electrode Sx having a relatively low resistance among the touch electrodes of FIG. 7 may be connected to the connection line RL and one connection electrode S2. That is, a touch electrode Sx having a relatively high resistance is connected to the connection line RL and two connection electrodes S2. However, the touch electrode Sx having the relatively low resistance has a portion P which is not connected and disconnected, and the branch electrode S1 and the connection line RL are connected to one connection electrode S2. As such, if the number of connection electrodes connected to the connection line is different, the movement path of the current is decreased or increased, such that a decrease and increase phenomenon of resistance due to the movement path occurs.

Since the touch sensor according to the present disclosure is the self sensing capacitor capable of detecting the touch information such as whether or not the touch occurs, the touch location, or the like from a change in a resistance value when a touch operation occurs, the touch electrodes are designed so as to have the same resistance value.

In the case in which the touch electrode is formed using the plurality of branch electrodes or opening parts as in the exemplary embodiments of the present disclosure, the resistance value of the touch electrode may be changed. Therefore, in the touch electrode having the relatively low resistance value, by disconnecting one of the plurality of connection electrodes S2 connected to the connection line RL so as to increase the resistance value, it is possible to maintain the resistance value to be equal to that of other touch electrodes.

Hereinabove, although the case in which the two connection electrodes and the connection line are connected has been described by way of example, the present disclosure is not limited thereto. For example, in the case in which the opening parts having various sizes are provided as shown in FIG. 6, more than two connection electrodes and the connection line may be connected, and the resistance value of the touch electrode may be easily adjusted by adjusting the number of connections of the connection electrodes and the connection line.

By way of summation and review, electrodes in a conventional sensing sensor may be formed of a transparent conductive film, e.g., indium tin oxide (ITO), or the like, coated with a thin film. However, since the electrodes have weak twist property due to a thin film made of an inorganic material, it is disadvantageous to implement flexibility of a finished product. Attempts have been made to make the thin film of the electrodes with a highly transparent and conductive silver nanowire ink technology. However, a coating layer formed by the silver nanowire ink has increased pattern visibility due to haze. Therefore, the present disclosure provides a touch panel having decreased haze, thereby providing improvised visibility even when the sensing electrodes are formed of a silver nanowire.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A touch sensor, comprising:
a plurality of touch electrodes on a touch area to sense touch, each of the touch electrodes having a plurality of branch electrodes parallel to each other in a first direction; and
connection lines on the touch area and connected to the touch electrodes, the connection lines extending in the first direction in parallel to the branch electrodes,
wherein a width of the connection line and a width of the branch electrode are equal to each other.

2. The touch sensor as claimed in claim 1, wherein the connection lines and the branch electrodes are disposed at an equidistant interval in the touch area.

3. The touch sensor as claimed in claim 2, wherein a width between the connection lines is equal to the width of the connection line.

4. The touch sensor as claimed in claim 2, wherein a width between the branch electrodes is equal to the width of the branch electrode.

5. The touch sensor as claimed in claim 2, wherein a width between the branch electrodes is different from the width of the branch electrode.

6. The touch sensor as claimed in claim 1, further comprising at least one connection electrode connecting neighboring branch electrodes.

7. The touch sensor as claimed in claim 6, wherein the connection electrode is connected to the branch electrode to be perpendicular to the branch electrode.

8. The touch sensor as claimed in claim 7, further comprising an opening part between the neighboring branch electrodes, the connection electrode being at one side of the opening part.

9. The touch sensor as claimed in claim 8, wherein the connection electrode connects the neighboring branch electrodes across the opening part.

10. The touch sensor as claimed in claim 1, wherein the touch electrodes are disposed in rows and columns.

11. The touch sensor as claimed in claim 10, wherein the connection lines extend along columns of the touch electrodes, a grouping of connection line among the connection lines being positioned between every two neighboring columns of touch electrodes.

12. The touch sensor as claimed in claim 10, wherein facing sides of the touch electrodes which are adjacent in the column direction have a step shape.

13. The touch sensor as claimed in claim 12, wherein the step shapes of the facing sides are engaged with each other.

14. The touch sensor as claimed in claim 12, wherein the facing sides have the step shape formed in a direction in which the facing sides are repeatedly increased or decreased as the facing sides become distant from the connection line.

15. The touch sensor as claimed in claim 1, wherein the width of the connection line and the width of the branch electrode are about 10 μm to about 100 μm.

16. The touch sensor as claimed in claim 1, wherein the touch electrode includes at least one of indium tin oxide (ITO), indium zinc oxide (IZO), a metal nanowire, and a conductive polymer.
